(19) United States
(12) Patent Application Publication
(10) Pub. No.: US 2017/0363896 A1
(43) Pub. Date: Dec. 21, 2017

(54) Sunlight Attenuation Visor

(71) Applicants: Yongwu Yang, Belmont, MA (US); Canwen Liu, Belmont, MA (US)

(72) Inventors: Yongwu Yang, Belmont, MA (US); Canwen Liu, Belmont, MA (US)

(21) Appl. No.: 15/187,769

(22) Filed: Jun. 20, 2016

(51) Int. Cl. G02F 1/133; G02F 1/1335; G02F 1/1368; G02F 1/137; G02F 1/1343

(52) U.S. Cl. CPC G02F 1/13318; G02F 1/137; G02F 1/134336; G02F 1/1368; G02F 1/133528; G02F 2001/13312; G02F 2001/133531; G02F 2001/13756

(57) ABSTRACT

A light attenuation apparatus for adjusting the intensity of light transmitted through the apparatus, comprises: a light detector array for measuring light intensity incident on the light attenuation apparatus; and LCD filter panel, comprising: a first polarizer having a polarizing orientation; a second polarizer; a first substrate with a plurality of electrodes, a second substrate having a plurality of electrodes perpendicular to the first substrate. The first and second substrates disposed between the polarizers. An LCD filter grid has nematic liquid crystals inside the grid to form a plurality of pixels. Each pixel comprises a filter and the LCD filter grid is disposed between the substrates with a plurality of electrodes. A voltage driver controls the voltage level applied to the electrodes based on the intensity of the measured light wherein the voltage determines the amount of light transmitted through the apparatus. Each pixel is independently addressed by the voltage driver.

### TECHNICAL FIELD

The present invention relates to an adjustable light attenuation apparatus with a video rate light intensity distribution mapping sensor, and more particularly, it relates to an automatic light attenuation apparatus adapted for use in automobiles or air planes to provide vehicle operators with comfortable light exposure throughout the view of the operator.

### BACKGROUND OF THE INVENTION

In addition to the problems (see FIG. 1) described in U.S. Pat. No. 8,083,385 issued to Yongwu Yang and incorporated herein by reference in its entirety, the sun light seen by the driver is not uniform in his/her field of view. Its distribution across the windshield is not even (see FIG. 2), sunlight in some areas is much stronger than in the other areas. In addition, the distribution of sun light across the windshield changes depending on the driving direction and the time of the day. Thus there is a need to monitor and track the sun light distribution in real time and to attenuate the sun light according to the light distribution across the driver's view through windshield and thus provide the driver with a rather even and comfortable light distribution in his/her field of view.

Current visor attenuation techniques include tinted glass or a liquid crystal panel to filter out sunlight across the whole area with the same degree of filtering. In the case of the tinted glass, the degree of the filtering is fixed. It thus only reduces the intensity of the sunlight to a certain degree but it could still be too hazardous when the sun is directly shinning to the driver. In the case of the liquid crystal panel currently on the market, although the degree of filtering is automatically or manually changeable according to the sunlight intensity, the whole panel is changed to the same degree of filtering. Thus in order to filter out strong sunlight in some area to reach a comfortable level, the whole liquid crystal panel is tuned to filter out the strong sunlight in that area. However, the other parts of the panel will be too dark and will affect the driver's view. Otherwise, the sunlight in the strongest area is still too strong for comfortable viewing (see FIG. 3 for example).

### BRIEF SUMMARY OF EMBODIMENTS OF THE INVENTION

A sun visor includes a 2 dimensional (2D) light detector array, and/or a few light detectors, a signal processor, a voltage driver, and a 2D multi-pixel LCD filter panel. The 2D light detector array, such as that in a webcam, or in a camera in a smart phone, a tablet or tablet device, etc. has at least the field view of a person operating a vehicle (driver), and detects a light intensity distribution in the windshield of a vehicle. The 2D light intensity distribution information is transmitted at a video rate to a signal processor which correlates the measured sun light intensity distribution to the actual light distribution in the windshield in the driver's view and creates a 2D voltage map for the voltage driver according to the light distribution. The voltage driver receives voltage commands from the signal processor and provides voltages to the individual pixels of an LCD filter panel (such as that used in an LCD computer monitor or an LCD TV) to adjust the degree of the light filtering accordingly. The pixels of LCD panel with strong light have high voltages and thus they reduce more incoming light and let less light through, and vice versa. The pixels of the LCD panel with light intensity less than a preset threshold will receive zero voltage and thus all light is let through without any further attenuation. Therefore, within the driver's view, the parts with strong sunlight are filtered out more strongly and the parts with less sunlight are less filtered via the LCD panel. The driver thus sees roughly even light distribution within his/her comfortable range.

Other features and aspects of the invention will become apparent from the following detailed description, taken in conjunction with the accompanying drawings, which illustrate, by way of example, the features in accordance with embodiments of the invention. The summary is not intended to limit the scope of the invention, which is defined solely by the claims attached hereto.

### BRIEF DESCRIPTION OF THE DRAWINGS

The present invention, in accordance with one or more various embodiments, is described in detail with reference to the following figures. The drawings are provided for purposes of illustration only and merely depict typical or example embodiments of the invention. These drawings are provided to facilitate the reader's understanding of the invention and shall not be considered limiting of the breadth, scope, or applicability of the invention. It should be noted that for clarity and ease of illustration these drawings are not necessarily made to scale.

Some of the figures included herein illustrate various embodiments of the invention from different viewing angles. Although the accompanying descriptive text may refer to such views as “top,” “bottom” or “side” views, such references are merely descriptive and do not imply or require that the invention be implemented or used in a particular spatial orientation unless explicitly stated otherwise.

FIGS. 1-2 illustrate problems associated with direct sunlight on vehicle operators.

FIG. 3 illustrates use of a device in accordance with the invention.

FIG. 4 is a flow chart of a process of light attenuation.

FIG. 5A is a perspective view of an auto-track, auto-adjustable sun visor.

FIG. 5B is an exploded view of an auto-track, auto-adjustable sun visor.

FIG. 6A is a perspective view of an auto-adjustable sunlight attenuation apparatus with a traditional visor in an unfolded position.

FIG. 6B is a perspective view of an embodiment of the auto-adjustable sunlight attenuation apparatus with a traditional visor in a folded position.

FIG. 7 is a rear perspective view of an embodiment of the auto-adjustable sunlight attenuation apparatus with a traditional visor in a folded position.

FIG. 8 is a perspective view of an embodiment of the sunlight attenuation apparatus suitable for use with a powered retracting unit.

FIG. 9 is a perspective view of an embodiment of the auto-adjustable sunlight attenuation apparatus having a module for recording driving events and having a memory stick slot 510 for accepting memory to record and store images and video.

FIG. 10 is a flow chart illustrating a method of auto-adjustable sunlight attenuation in accordance with the principles of invention.

FIG. 11 is a flow chart illustrating a method of auto-adjustable sunlight attenuation with feedback light detection installed.

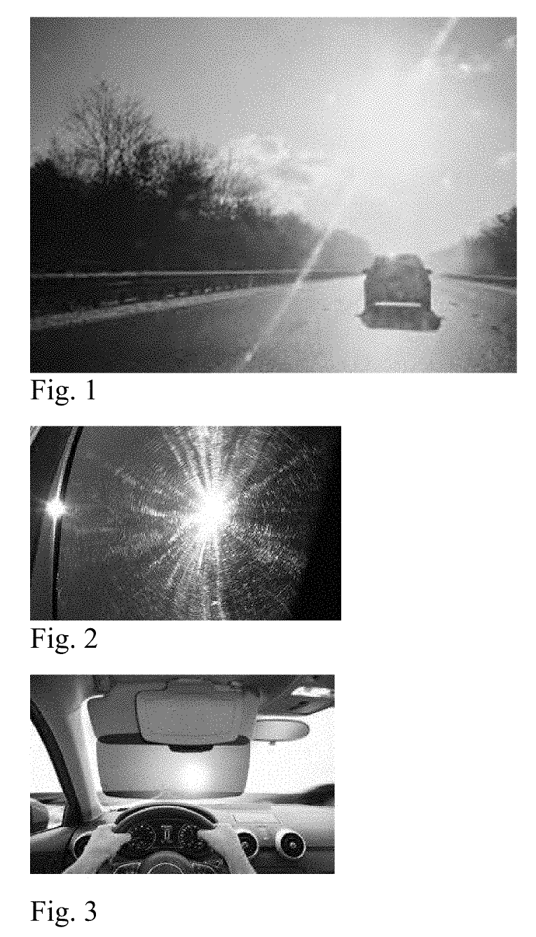

The figures are not intended to be exhaustive or to limit the invention to the precise form disclosed. It should be understood that the invention can be practiced with modification and alteration, and that the invention be limited only by the claims and the equivalents thereof.

### DETAILED DESCRIPTION OF THE EMBODIMENTS OF THE INVENTION

From time to time, the present invention is described herein in terms of these example environments. Description in terms of these environments is provided to allow the various features and embodiments of the invention to be portrayed in the context of an exemplary application. After reading this description, it will become apparent to one of ordinary skill in the art how the invention can be implemented in different and alternative environments. Unless defined otherwise, all technical and scientific terms used herein have the same meaning as is commonly understood by one of ordinary skill in the art to which this invention belongs.

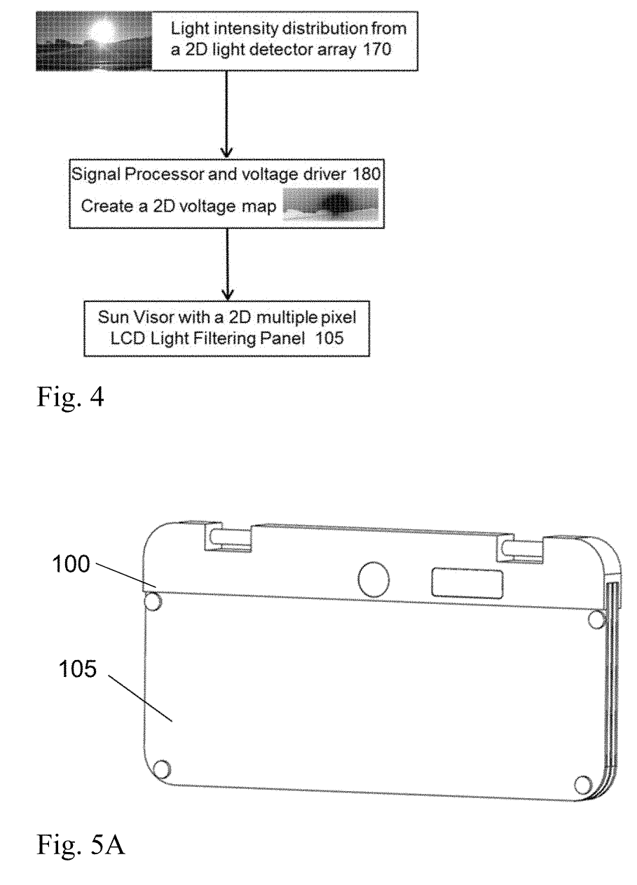

Referring to FIG. 4, an auto-track, auto-adjustable sun visor method and apparatus is described. In a step 70, a 2D light detector array, such as a webcam or camera in a smart phone, tablet, etc. with at least driver's field of view tracks sunlight distribution with a video rate in real time 170.

In a step 180, a signal processor processes a 2D sunlight distribution and correlates sunlight distribution in the windshield to the light distribution on the LCD panel. A 2D voltage map is generated and the voltage driver is directed to send a 2D map of voltages to a 2D multi-pixel LCD filter panel similar to that used in an LCD computer monitor or an LCD TV without color filters or back light. The driver controls the LCD such that regions of higher light intensity corresponds to higher voltage, and regions of lower intensity are applied with a lower voltage. The voltage will be zero for light intensity below a preset threshold according to some standard or adjustable to driver's comfortable level. Power supply to the device can be provided either from the 12V car outlet or from sunlight through a solar cell.

Each pixel of the LCD filter panel is individually addressed and the degree of filtering changes according to the voltage provided in the 2D voltage map for this pixel. Pixels with stronger light intensity are supplied with higher voltage and thus the light at these pixels is attenuated more and pixels with weaker light intensity are given lower voltage and thus the light at those pixels is attenuated less. Zero voltages are supplied to pixels with light intensity lower than the preset threshold and thus light at these pixels is transmitted without any attenuation. Thus, the driver sees a roughly uniform light distribution across his/her whole view within a comfortable range and avoids a strong sunlight sting and is thus able to have a clear field of view.

In another embodiment, one or more light detectors are installed behind the LCD filter panel which detect transmitted light as seen by the driver. The detected light intensity feeds back to the signal processor and voltage driver to further control the light after the LCD filter panel to ensure that it is within the predetermined light range.

Parts to assemble the present invention may be taken from parts of other products on the market and thus may be readily available without the need to build a new production line which can be very expensive. For example, webcam or camera on the cell phone, tablet, etc. can be used as the 2D light detector array, LCD panel from an LCD TV or LCD computer monitor without the white illuminating light and color filters can be used as the LCD filter panel.

The device may be contained within a thin plate just like a visor as described in FIG. 3, and with a power line or with a solar cell as a power supply. It can be installed in new cars, and can also be retrofitted to old cars to benefit the larger population.

Optionally, a motor can be installed to automatically lower the LCD panel to the lower part of the windshield when sunlight is shining to the lower part of the windshield (at sunrise or sunset time). Optionally, the 2D light detector array can also be used as a dashboard camera recorder to record driving events.

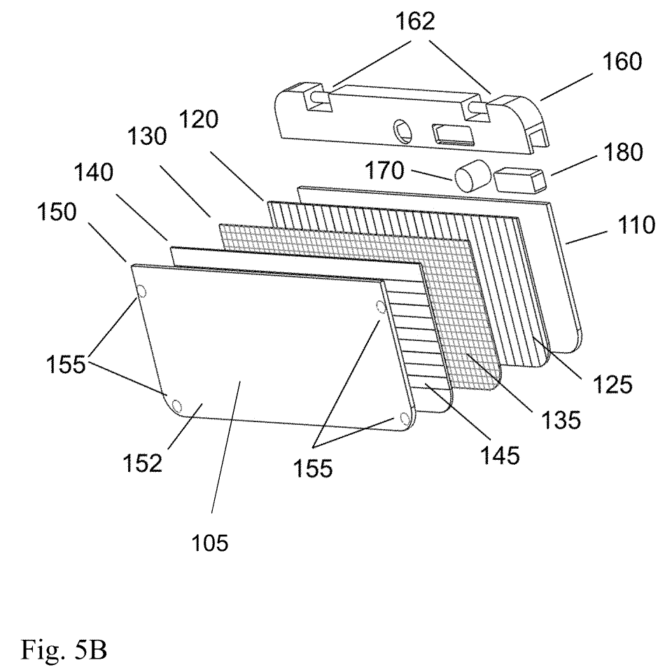

FIG. 5A is a perspective view of a preferred embodiment of the auto-adjustable sunlight attenuation apparatus. FIG. 5B shows an exploded view of a sunlight attenuation apparatus 100. In one embodiment, the apparatus comprises: a 2D multi-pixel LCD filter panel 105; a 2D light detector array 170 configured to measure light incident on the light attenuation apparatus; a signal processor and voltage driver 180; and a frame 160 to hold the components mentioned above. The 2D LCD filter panel 105, like that used in LCD computer monitor or LCD TV, further includes: a first polarizer film 110; a glass or plastic substrate 120 with rows of transparent indium tin oxide (ITO, or tin-doped indium oxide) electrodes 125 coated thereon; an LCD filter grid 135 with twisted nematic liquid crystals sandwiched in the LCD filter grid to form multiple individual filters or pixels; another glass or plastic substrate 140 with columns of common electrode film (ITO) 145 coated thereon; and a second polarizer film 150. The first polarizer 110 is oriented vertically and polarizes light transmitted through the first polarizer 110. Approximately 50% of the light is absorbed by the first polarizer 110 and approximately 50% of the light passes through and is polarized vertically. The liquid crystal molecules in each pixel are twisted in between the two glass or plastic plates 120, 140. When no voltage is applied to the electrodes 125 and 145, the vertically polarized light transmitted and filtered from the first polarizer 110 is rotated by the helix of the nematic liquid crystals in each pixel as the light travels through the liquid crystal grid 135. When the light exits the liquid crystal grid 135, the polarization of the light is rotated by 90 degrees at the zero voltage. Thus, the light can pass through the second polarizer film 150 which is oriented horizontally. In all, approximately 50% of the total light is transmitted through an embodiment of the apparatus 100 under no electric field.

Each filter or pixel is addressed independently through applying voltage to one column in 125 and one row in 145. When a voltage is applied to a column in 125 and a row in 145, an electric field is generated at the crossing point of the row and column. The twisted liquid crystals at that pixel are forced to rotate to align its long molecular axes in the field direction. This rearrangement of molecules distorts the helical structure formed by the molecules under electric field.

As mentioned above, the polarization change that occurs in the light after passing the first polarizer 110 will depend on the twisted helical structure of the liquid crystal molecules. When the helical structure is distorted due to the applied electric field, the amount of polarized light being rotated and subsequently the amount of light transmitted through the second polarizer film 150 is reduced, i.e., the luminous transmittance of that pixel is decreased. When the helical structure is distorted under a high electric field, the polarization state of the light passing through the first polarizer film 110 is unaffected as the light travels through the liquid crystal pixel. Therefore, the light will be absorbed by the second polarizer 150 and no light will pass through. In other words, all light is blocked and that pixel has a transmittance of 0%. In short, the amount of light allowed to pass through each pixel is tunable between 0% and approximately 50% by controlling the voltage to the rows of electrodes 125 and columns of electrodes 145 across the nematic liquid crystal grid 130.

The minimum transmission of each pixel of the apparatus 100 is set at some value above 0% according to current standard or future established standards for automobiles. In one embodiment of the apparatus, this may be accomplished by configuring a power supply with a maximum output to each individual pixel that yields the set minimum transmittance. The device may then be safely operated between the luminous transmittance of 50% and the set minimum by adjusting the voltage from zero to its maximum.

The voltage applied to each pixel in the LCD filter grid 130 is determined by the light distribution across the windshield collected by the 2D light detector 170. For the pixels with very strong light, the voltage will be high for those pixels and the light will be attenuated more, and vice versa. Since each pixel is addressed independently according to the light distribution, the light attenuation will vary across the apparatus independently and in real time, so that the driver will see a rather roughly even light distribution across his/her field of view.

In another embodiment, one or more photo detectors 155 positioned behind an outer side 152 of the second polarizer 150 measure the light (i.e., the amount of light a driver sees) transmitted through the apparatus 100. The output or the average output of all photo detectors 155 provides a feedback to the voltage driver 180. The voltage driver then automatically adjusts the voltage level to rows of electrodes 125 and columns of electrodes 155 to achieve the preset light transmission. Despite the sunlight strength and brightness variation (affected by the time of the day, weather conditions, the time of the year, the road direction, and road curvature), the apparatus automatically tracks the sun position and measure the light distribution in driver's field of view and automatically filters out the proper amount of sunlight according to its distribution in real time and allows a relatively constant and even amount of light throughout the whole apparatus. By automatically adjusting the voltage to the rows of electrodes 125 and columns of electrodes 145 across the liquid crystal grid 130, the amount of sunlight attenuated is automatically adjusted to maintain constant transmittance. Thus, one advantage of the apparatus is that a driver senses relatively even, constant, and comfortable light levels across his/her field of view at all times, independent of sun position, time of the day, and road curvature. The driver will be relieved from the strong sunlight glare and the driver's view is thus greatly enhanced.

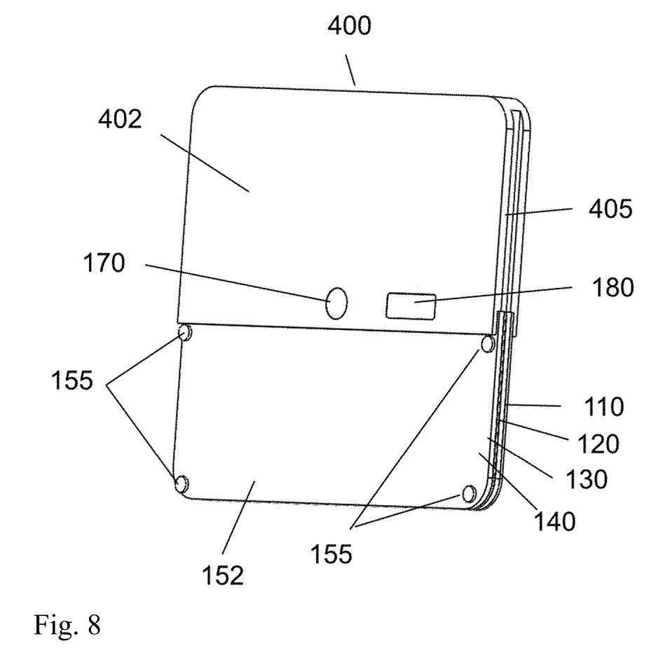

In another embodiment, referring to FIG. 8, a motor is installed to automatically roll the apparatus down to the lower part of the windshield when the sun is on the horizon and sun light is shining through the lower part of windshield.

In another embodiment, the LCD filter panel uses an active matrix design. In this design, each filter (pixel) is paired additionally with a thin-film transistor in the front glass or plastic panel 125. A new addressing line, called the gate line, is added as a separate switch for the transistor. When the voltage is high, say 5V, the transistor is switched on; when the voltage is low, say 0V, the transistor is switched off. An LCD filter or pixel will be addressed so only when a cross field of the row and column is established and the transistor is switched on.

In another embodiment, the 2D light detector array can also be used as a dashboard camera or driving recorder with a memory chip 510 installed, such as those used in cell phones, cameras etc. The driving events on the road are live recorded by the 2D light detector array and saved onto the memory.

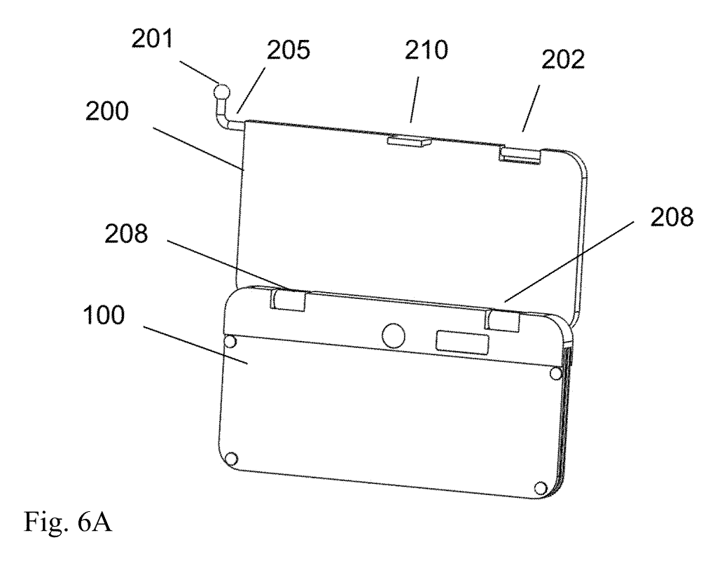

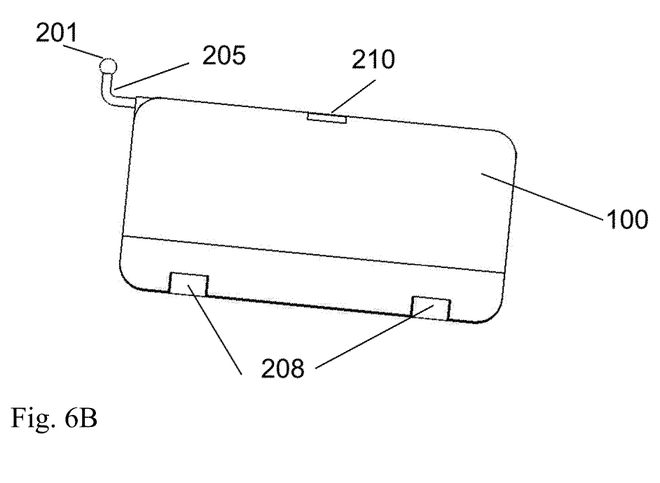

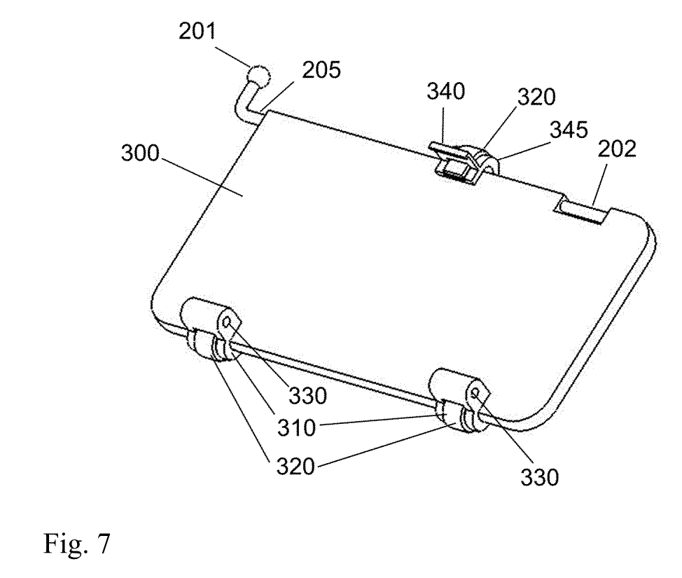

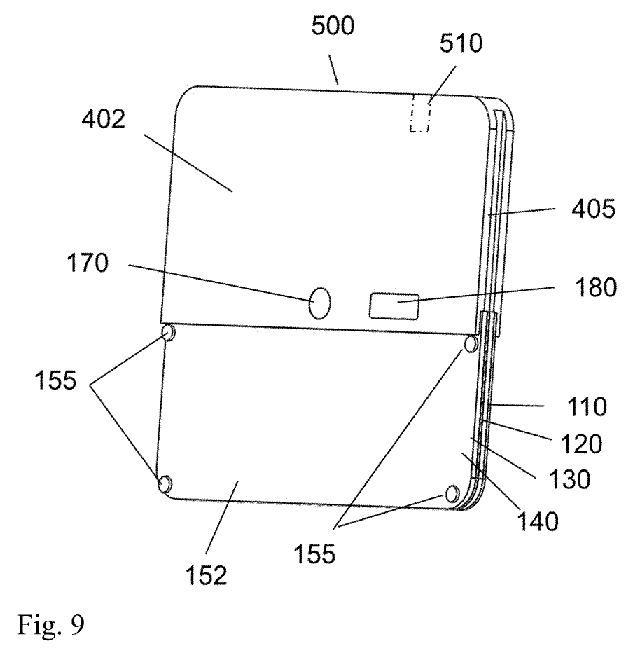

FIG. 6A is a perspective view of the auto-adjustable sunlight attenuation apparatus with a traditional visor in an unfolded position and FIG. 6B is a perspective view of an embodiment of the auto-adjustable sunlight attenuation apparatus with a traditional visor in a folded position. FIG. 7 is a rear perspective view of an embodiment of the auto-adjustable sunlight attenuation apparatus with a traditional visor in a folded position. FIG. 9 is a perspective view of an embodiment of the auto-adjustable sunlight attenuation apparatus having a module for recording driving events and having a memory stick slot 510 for accepting memory to record and store images and video.

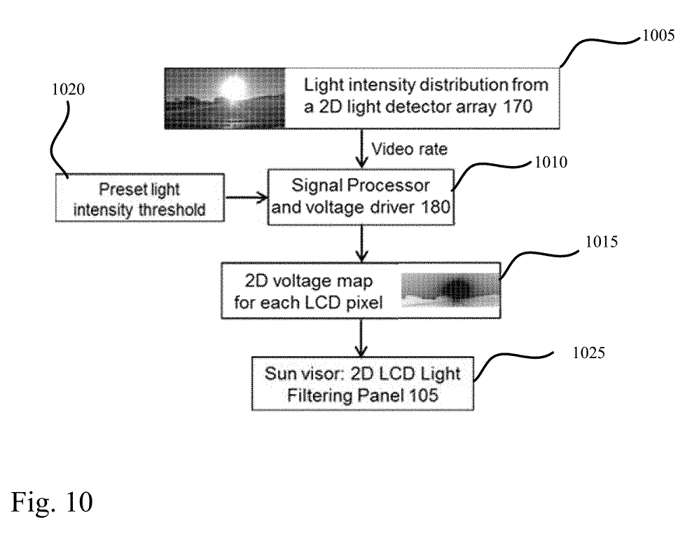

FIG. 10 is a flow chart illustrating a method of auto-adjustable sunlight attenuation in accordance with the principles of invention. In operation, referring to FIG. 10, the 2D light intensity detector array 170, which has at least the field of view of a driver, measures 1005 the light distribution across the whole windshield and sends 1010 the 2D light distribution information to a signal processor 180 at a video rate. The signal processor, in a step 1015 processes the 2D intensity information and creates a 2D voltage map table for the voltage driver according to the preset light intensity threshold 1020. For the light intensity less than the threshold, the voltage is set to zero. For the light intensity above the threshold, the voltage is linearly correlated to the measured light intensity from 0 to the preset highest voltage. The number of rows and columns of the voltage map table corresponds to the number of pixels in each column and row. In a step 1025, the voltage driver then delivers a voltage for each individual pixel of the LCD filter panel according to the 2D voltage map table. The higher the light intensity in the light distribution, the higher the voltage will be for the pixel of the LCD filter panel to reduce the light level seen by the driver to a preset comfortable level. The lower the light intensity, the lower the voltage will be for the pixel and thus less light attenuation. Therefore, the driver will see a rather uniform and comfortable level of light distribution across the windshield in his or her field of view.

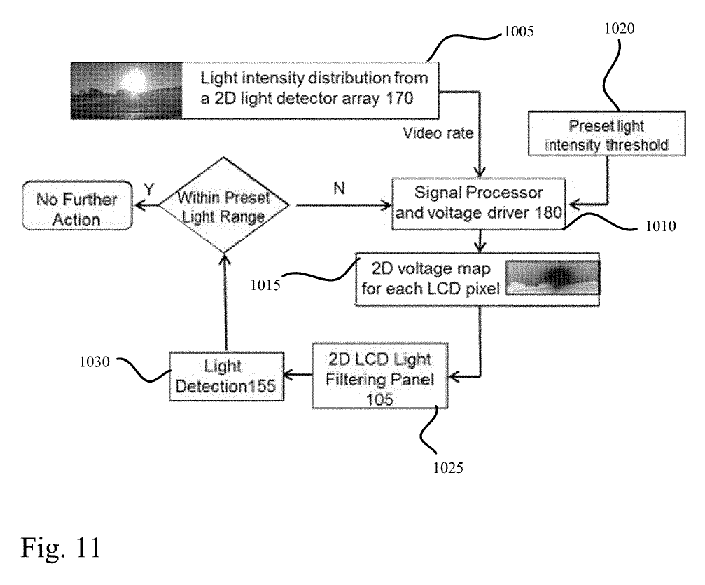

In another embodiment, referring to FIG. 11, a flow chart illustrates a method of auto-adjustable sunlight attenuation with a feedback light detection installed. One or more additional light detectors 155 are installed in the back of LCD panel, and detect light intensity after the light passes through the LCD filter panel and provide live feedback, in a step 1030, to the voltage driver to attenuate the light to be within the predetermined range.

What is claimed is:

1. A light attenuation apparatus for adjusting the intensity of light transmitted through the apparatus, comprising:
a light detector array for measuring the light incident on the light attenuation apparatus;
and LCD filter panel, comprising:
a first polarizer having a polarizing orientation;
a second polarizer having a polarizing orientation perpendicular to the polarizing orientation of the first polarizer;
a first substrate with a plurality of electrodes having a first orientation, a second substrate having a plurality of electrodes having a second orientation perpendicular to the first orientation, the first and second substrates disposed between the polarizers;
an LCD filter grid having nematic liquid crystals inside the grid to form a plurality of pixels, each pixel comprising a filter, the LCD filter grid disposed between the substrates with a plurality of electrodes;
a voltage driver in electrical communication with the light detector array for controlling the voltage level applied to the electrodes based on the intensity of the measured light wherein the voltage determines the amount of light transmitted through the apparatus, wherein each pixel is independently addressed by the voltage driver via applying a voltage to an appropriate electrode on each of the first and second substrates.

2. The light attenuation apparatus of claim 1, wherein a maximum power output to each pixel is configured to set a minimum transmittance through each pixel.

3. The light attenuation apparatus of claim 1, further comprising a photo detector positioned to receive light filtered by the LCD filter grid, wherein the output of the photodetector feeds back on the voltage driver, and wherein the voltage driver is configured to adjust the voltage to electrodes to achieve a predetermined light transmission through the grid.

4. The light attenuation apparatus of claim 1, wherein the LCD filter grid comprises an active matrix, wherein pixel is paired with a thin-film transistor.

5. The light attenuation apparatus of claim 4, wherein the thin-film transistor is disposed in the substrate.

6. The light attenuation apparatus of claim 5, further comprising a gate line, comprising a separate switch for each transistor.

7. The light attenuation apparatus of claim 5, wherein the light detector array is a video camera recorder.

9. A method of light attenuation, comprising:
positioning a light intensity detector array in a field of view of a vehicle operator;
measuring, at a location, the light distribution across the field of view;
sending the light distribution to a signal processor;
processing the intensity distribution to generate a voltage map of pixels for a voltage driver according to a preset light intensity threshold;
delivering a voltage for each pixel of an LCD filter panel, the panel positioned downstream of the measurement location, according to the voltage map, wherein:
for light intensity less than the threshold at a pixel, applying a 0 voltage for that pixel on the map; and
for light intensity above the threshold at a pixel, applying a voltage in a linearly correlated manner to the measured light intensity from 0 to a preset highest voltage, for that pixel on the map.

10. The method of claim 9, further comprising detecting light intensity after the light passes through the LCD filter panel; adjusting the voltage to be within a predetermined range, based on the detected light after passing through the LCD filter panel.
